(19) United States
(12) Patent Application Publication
(10) Pub. No.: US 2005/0255331 A1
(43) Pub. Date: Nov. 17, 2005

(54) Compound formable decorative laminate

(76) Inventors: Robert R. Krebs, Georgetown, TX (US); Michael E. Ingrim, Belton, TX (US); Virgil B. Canady, Temple, TX (US); Finian Hoelscher, Temple, TX (US); Billy Joe Billeck JR., Rogers, TX (US)

Correspondence Address: WILSONART INTERNATIONAL, INC., C/O WELSH & FLAXMAN, LLC, 2000 DUKE STREET, SUITE 100, ALEXANDRIA, VA, 22314, US

(21) Appl. No.: 10/845,068

(22) Filed: May 14, 2004

(51) Int. Cl. B32B 27/32; B32B 27/10

(52) U.S. Cl. 428/513; 428/523; 442/327; 442/412

(57) ABSTRACT

A compound formable decorative laminate includes a decorative layer composed of a bilaterally stretchable polyolefin decorative sheet and a resin impregnated core layer composed of a bilaterally stretchable kraft paper. The laminate is formed by providing a decorative sheet composed of a polyolefin that is bilaterally stretchable, providing a kraft paper that is bilaterally stretchable,—impregnating the kraft paper with a resin, layering the decorative sheet and the kraft paper, and—consolidating the layered decorative sheet and kraft paper under heat and pressure to form a sheet of decorative laminate.

### BACKGROUND OF THE INVENTION

1. Field of the Invention

The invention relates to decorative laminates. More particularly, the invention relates to the use of polyolefin sheet in combination with a stretchable, resin impregnated kraft paper in the manufacture of compound formable decorative laminates which may be selectively molded in a three-dimensional manner.

2. Description of the Prior Art

Decorative laminates have found widespread use as the ability to replicate natural materials has substantially improved over the years. For example, decorative laminates have replaced natural materials in the construction of countertops, furniture, store fixtures, signage, column wraps, appliance fronts, push and kick plates, ceiling panels, residential cabinetry, wall panels, decorative trim and accents for restaurant/food service equipment.

The laminate industry is continually striving to improve the functionality of decorative laminates. These advances in decorative laminate manufacturing make these materials equal to, or better than, the materials they are designed to replace.

Decorative laminates generally include plural layers of synthetic resin impregnated paper sheets bonded under heat and pressure to form a unitary structure. In normal practice, a decorative laminate sheet assembly, from the bottom up, includes a core layer of one or more phenolic resin impregnated sheets, above which lies a decorative melamine impregnated sheet. The decorative sheet may be further covered with a melamine impregnated overlay.

A substrate may also be bound to the decorative laminate to impart rigidity thereto. The substrate may be a pre-cured plastic laminate, such as glass fiber-reinforced thermoset polyester resin laminates and the like, a wood product, such as hardboard, wood waste or particle boards, plywood and the like, a mineral base board, such as, cement-asbestos board, sheet rock, plaster board, and the like, or a combination of substrates.

Decorative laminates are generally manufactured by placing the resin impregnated core and decorative sheet between steel plates and subjecting the laminate stack to heat and pressure for a time sufficient to consolidate the laminate and cure the resins. The pressure and heat force the resin in the paper sheets to flow, cure, and consolidate the sheets into a unitary laminated mass referred to in the art as a decorative high pressure laminate. Finally, the formed decorative laminate is bonded to a reinforcing substrate, such as, plywood, hardboard, asbestos board, particle board or the like.

Unfortunately, the resins and papers utilized in the manufacture of prior decorative laminates limit one's ability to alter the shape of the cured decorative laminate (that is, through subsequent forming processes). This is not to say that decorative laminates are unbending and totally unsuited for any application requiring that the decorative laminate be formed around a non-planar surface. However, currently available decorative laminates are limited in their ability to be “wrapped” about substrates having substantial surface variations.

Since those skilled in the art have previously been unable to develop a decorative laminate well suited for forming operations, various techniques have been developed to compensate for conventional decorative laminate's inability to be formed about irregular and/or non-planar surfaces. These techniques have met with only limited success and fabricators of decorative laminate remain limited to post-forming decorative laminates in a very limited number of ways. Specifically, fabricators are currently only able to post-form decorative laminates about a single axis lying within a single plane (that is, two-dimensionally), for example, in the formation of work surface edges or unitary backsplash/work surface structures where the decorative laminate is post-formed about a single axis. That is, current post-forming techniques allow one to wrap decorative laminate about the edge of a countertop but are not sufficiently developed to permit wrapping of the laminate around a countertop corner.

Current techniques limit the molding of decorative laminates in a three-dimensional space. It is the inventors' understanding that high pressure decorative laminate is currently being formed over/onto three-dimensional surfaces limited to those having a principle radii of curvature >0.5 inches. As such, many structures well suited for decorative laminate surfacing cannot take advantage of the durability, cost and pleasing appearance offered by decorative laminates. For example, the intricate profiles of six panel doors, cabinet facings, ergonomic desktops, finials, etc., may not be surfaced with decorative laminates due to the current unavailability of a decorative laminate which may be compound formed about the three-dimensionally based profiles required by these structures.

This shortcoming of available decorative laminates currently limits the use of decorative laminates to relative flat surfaces or simple curved surfaces. As those skilled in the art certainly appreciate, the number of surfaces that might be surfaced with decorative laminates, if not for the irregular, or non-planar, nature of their surfaces, would be greatly enlarged if a compound formable decorative laminate were available. Unfortunately, such a decorative laminate is not known in the prior art.

There are a number of decorative surfacing materials that are conformable to ergonomic desktops, cabinet doors, etc. These include vinyls, powder coatings, low basis weight papers, and wood veneers. All of these materials have surface properties that are, in general, inferior to high pressure decorative laminates. This includes stain resistance, impact resistance, heat resistance, and scratch/scuff resistance. A high pressure decorative laminate that is also highly formable, would, therefore, represent a significant improvement in the current decorative surfacing art.

A need, therefore, exists for a decorative laminate offering characteristics making more elaborate compound forming processes possible without sacrificing the outstanding surface properties currently offered by high pressure decorative laminate. The present invention provides such a decorative laminate.

### SUMMARY OF INVENTION

It is, therefore, an object of the present invention to provide a compound formable decorative laminate having a decorative layer composed of a bilaterally stretchable polyolefin decorative sheet and a resin impregnated core layer composed of a bilaterally stretchable paper.

It is also an object of the present invention to provide a laminate lay-up including a resin impregnated decorative layer composed of a bilaterally stretchable polyolefin decorative sheet and a resin impregnated core layer composed of a bilaterally stretchable paper.

It is another object of the present invention to provide a method of fabricating a compound formable decorative laminate. The method is achieved by providing a decorative sheet composed of a polyolefin that is bilaterally stretchable, providing a paper that is bilaterally stretchable, impregnating the paper with a resin, layering the decorative sheet and the paper, and consolidating the layered decorative sheet and paper under heat and pressure to form a sheet of decorative laminate.

It is a further object of the present invention to provide a compound formable decorative laminate panel including a decorative layer composed of a bilaterally stretchable polyolefin decorative sheet, a compound formable substrate and a resin impregnated core layer positioned between the decorative layer and the substrate.

It is yet another object of the present invention to provide a compound formable decorative laminate composed of a polyolefin decorative layer and a resin impregnated core layer.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the present decorative laminate in accordance with a first embodiment of the present invention.

FIG. 2 is a schematic of a compound forming process for a hemisphere utilized in accordance with the present invention.

FIG. 3 is a schematic of a compound forming process for a “peanut” shape utilized in accordance with the present invention.

FIG. 4 is a perspective view of a door panel formed in accordance with the present invention.

FIG. 5 is a cross sectional view of the door panel shown in FIG. 4.

FIG. 6 is a top view of a tabletop formed in accordance with the present invention.

FIG. 7 is a cross sectional view of the tabletop shown in FIG. 6.

FIG. 8 is a schematic of a compound formable low pressure decorative laminate formed in accordance with the present invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for teaching one skilled in the art how to make and/or use the invention.

The present invention relates to a decorative laminate that may be compound formed along three-dimensions, that is, a surface with two finite principle radii of curvature, via either expansion of the decorative laminate or contraction of the decorative laminate. The terms “compound formed”, “compound formable” and variations thereof are used throughout the body of the present specification to describe the molding of decorative laminates in a three-dimensional space not limited to a single axis, that is, about multiple axes and with differing curvatures and radii.

The compound formable decorative laminate includes a decorative layer composed of a bilaterally stretchable decorative sheet which may be stretched at least approximately 20% to 50% in all in-plane directions and a resin impregnated core layer composed of a bilaterally stretchable kraft paper which may be stretched at least approximately 20% to 50% in all in-plane directions. While specific ranges are disclosed above, kraft papers which stretch as much as 100% are known in the prior art and could possibly be used in accordance with the present invention. The stretchable nature of the decorative sheet and the kraft paper permits expansion and contraction of the decorative laminate as the laminate is compound formed in the manner discussed below.

The laminate is fabricated by preprocessing a decorative sheet such that it is uniformly bilaterally stretchable, preprocessing a kraft paper such that it is bilaterally stretchable, impregnating the preprocessed kraft paper with a resin, layering the decorative sheet and the kraft paper and consolidating the layered decorative sheet and kraft paper under heat and pressure to form a sheet of decorative laminate. As will be discussed below in greater detail, the consolidation process is similar to that employed with traditional high pressure decorative laminates.

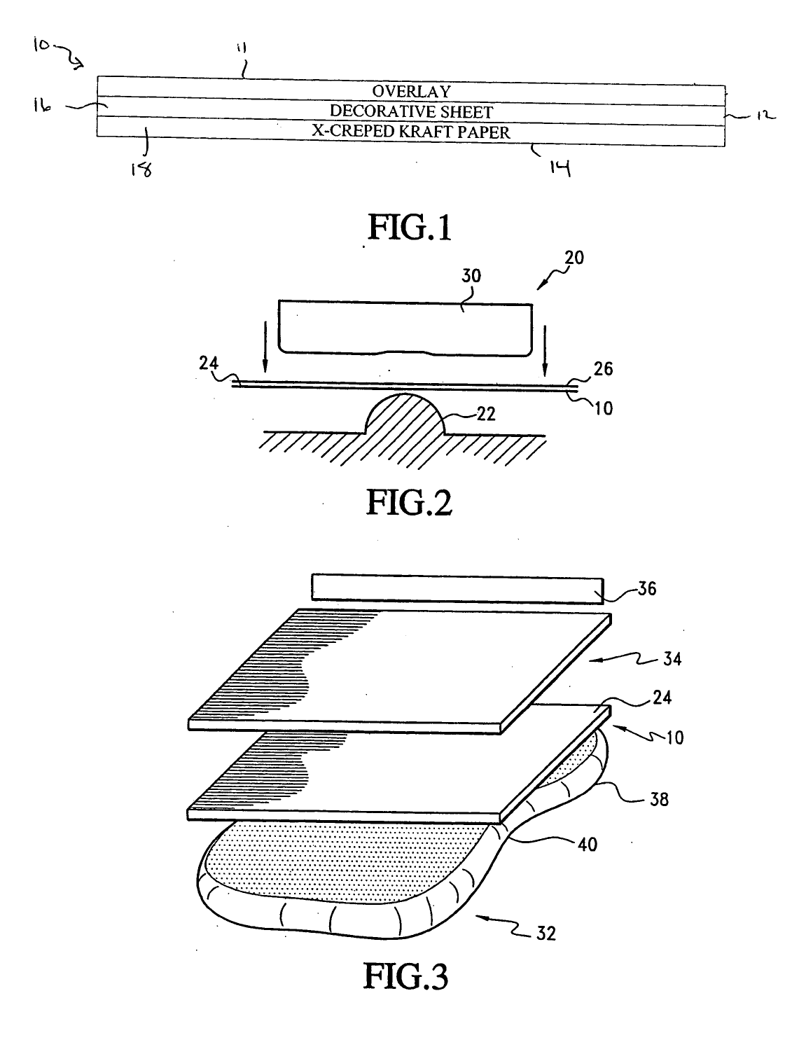

With reference to FIG. 1, a decorative laminate 10 in accordance with a preferred embodiment of the present invention is disclosed. The decorative laminate 10 includes a protective overlay 11, a decorative layer 12 and a core layer 14. While a specific layering pattern is disclosed in accordance with a preferred embodiment of the present invention, the layering pattern may be varied, somewhat, without departing from the spirit of the present invention.

The decorative layer 12 is a patterned decorative sheet 16 positioned directly above the core layer 14. The decorative layer 12 is substantially responsible for the aesthetic appearance of the finished decorative laminate 10. Decorative layers may be chosen from a wide array of sheets. For example, the decorative layer may be a solid color (for example, white) or include an aesthetically appealing pattern, such as, a wood grain or abstract pattern.

As discussed above, the decorative layer 12 provides the laminate 10 with an attractive appearance. The surface characteristics of the decorative laminate 10 are enhanced by the provision of an overlay 11. The overlay 11 forms the outer surface of the decorative laminate 10 and consequently dictates the surface characteristics of the final decorative laminate 10. For example, the composition of the overlay 11 helps to dictate the decorative laminate's resistance to chemical agents, heat, light, shock and abrasion.

In accordance with a preferred embodiment of the present invention, the overlay 11 is a nonwoven material adapted for bilateral stretching similar to that provided by the decorative layer 12 and the core layer 14. For example, it is contemplated the overlay 11 may be formed from a polyester/rayon blend, wherein polyester constitutes approximately 25% to 50% of the blend and rayon constitutes approximately 50% to 75% of the blend. It is also contemplated a 100% polyester nonwoven sheet, including minimal to zero amounts of titanium dioxide (to improve the transparency of the sheet when used as an overlay), may be employed within the spirit of the present invention. Most North American polyester fibers contain titanium dioxide. Titanium dioxide is used to deluster the fibers. The titanium dioxide adds haze to the overlay. The fibers also frequently contain an optical brightening agent. For this application optical brightening agents are not desired. Regardless of the material employed in practicing the present invention, the overlay 11 must exhibit high transparency and stretch characteristic allowing it to form with the underlying layers.

The overlay 11 employed in accordance with a preferred embodiment of the present invention is melamine impregnated in substantially the same manner as employed with respect to traditional overlays used in the production of decorative laminates. In general, the blend sheet or polyester sheet is impregnated with approximately 40% to approximately 80% melamine resin. Once impregnated, the sheet is dried, partially cured and finally cut into sheets. In addition, the overlay 11 may be provided with Al₂O₃ inclusions for improving wear and abrasion resistance

In some circumstances it may be desirable to omit the overlay 11 and allow the decorative layer 12 to also provide for the durability of the present decorative laminate 10. Where the decorative layer 12 forms the outer surface of the laminate 10, the decorative layer 12 will dictate the surface characteristics of the final decorative laminate 10. For example, the composition of the decorative layer 12 helps to dictate the decorative laminate's resistance to chemical agents, heat, light, shock and abrasion.

In accordance with a preferred embodiment of the present invention, the decorative layer 12 is composed of a single decorative sheet 16. The decorative sheet is a polyolefin sheet. In accordance with a preferred embodiment, the polyolefin sheet is ECO-FILM manufactured by Toppan, which is polyolefin sheet material. The ECO-FILM sheet material has a priming layer which assists in its bonding to the resin impregnated kraft paper layers. In addition, top layer provides abrasion and scratch resistance similar to that found in traditional melamine resin impregnated decorative layers. The decorative sheet 16 may include a solid color, a decorative design, or a rotogravure reproduction of natural materials, such as, wood, marble, leather, etc. The aesthetic characteristics of the decorative sheet 16 are revealed as the laminate's decorative design upon completion of the decorative laminate 10. However, the ECO-FILM may not be as durable as conventional melamine impregnated decorative layers and it is, therefore, contemplated the decorative layer 12 may be further treated with a surface coating of melamine resin or melamine resin with Al₂O₃, dried and β-staged like conventional decorative papers treated with melamine resin.

The core layer 14 is preferably formed from a single phenolic resin impregnated sheet of kraft paper 18, although other materials may be used without departing from the spirit of the present invention. The core layer 14 is constructed to be very thin so as to minimize the thickness of the resulting laminate 10, while similarly providing a stable structural member, and improve the compound formability of the resulting decorative laminate 10. With this in mind, the core layer 14 includes a single sheet of phenolic resin impregnated kraft paper 18. In accordance with a preferred embodiment of the present invention, before x-creping the kraft paper had a basis weight of 123.7 g/m², however, those skilled in the art will appreciate that the weight may be varied without departing from the spirit of the present invention.

While a single sheet of kraft paper is disclosed above in accordance with a preferred embodiment of the present invention, it has been found that multiple sheets of kraft paper may be used without departing from the spirit of the present invention. For example, 2 sheets of kraft paper produce very good results, while 3 and 4 sheet core layers are compound formable but do not produce the detail of thinner core layers. In accordance with previously tested embodiments of the present invention, a compound formable laminate including a single core sheet and a single decorative sheet has a thickness of approximately 0.483 mm, a compound formable laminate including two core sheets and a single decorative sheet has a thickness of approximately 0.737 mm, a compound formable laminate including three core sheets and a single decorative sheet has a thickness of approximately 1.054 mm and a compound formable laminate including four core sheets and a single decorative sheet has a thickness of approximately 1.422 mm.

The kraft paper 18 of the core layer 14 is creped to provide “crinkling” in both the x and y directions. More particularly, and prior to impregnation with the resin, the kraft paper 18 is bilaterally creped in both the x and y directions. In accordance with a preferred embodiment of the present invention, the paper 18 is creped using the x-crepe system of Cindus, Inc. Specifically, x-crepe describes a creping system in which a paper sheet is treated with crossing sets of creping crinkles diagonally disposed in the direction of the web. Sheets of this type, which are universally stretchable, have been made in accordance with the teachings of a number of patents including U.S. Pat. No. 2,008,181 Kemp, U.S. Pat. No. 2,008,182 Kemp, U.S. Pat. No. 2,071,347 Kemp, U.S. Pat. No. 2,399,256 Rowe, U.S. Pat. No. 2,567,967 Rowe, U.S. Pat. No. 2,610,935 Rowe, and U.S. Pat. No. 3,476,644 Krehnbrink These sheets further provide for contraction or compression thereof due to the crinkled nature of the creping.

The creping process is described in detail in the foregoing patents. Briefly, the process comprises the steps of dunking the paper sheet in water, applying a rosin to the sheet so that it will adhere to a drum and finally peeling the sheet off a drum with a blade which causes the paper to crinkle much like paint which is scraped from a surface. The resulting x-creped kraft paper is capable of stretching to 20% to 50% in all in-plane directions.

The x-creped kraft paper 18 is then impregnated throughout with a phenolic resin and is partially cured (β-staged). It has been found that the x-creped kraft paper 18 used in accordance with a preferred embodiment of the present invention absorbs resin more quickly than the non-creped kraft paper. As such, kraft paper with a resin content of approximately 44% to 50% has been used in accordance with the present invention, however, lower resin content is desirable to reduce “flash” or excess resin exuding from the laminate during the pressing step. As a matter of fact, laminate with a resin content of as low as 30% has been produced in accordance with the present invention and it is expected that number may be even further reduced with modified treating techniques. With this in mind, it is contemplated that kraft paper with a resin content of between approximately 20% and 50% may be employed in accordance with the present invention.

While x-creped kraft paper is disclosed in accordance with a preferred embodiment of the present invention, other creped papers offering bilateral stretching may be used in accordance with the present invention. For example, it is contemplated that Italian “moulding paper” may be used in accordance with the present invention. “Moulding paper” is a finely creped paper offering stretch characteristics required in accordance with the present invention. For example, Cartiere Cariolaro SpA and Gruppo X di X Gruppo manufacture such a paper. Information concerning the paper may be readily found at www.cariolaro.com/cariolaro/Eng//MouldPaper.htm.

The decorative laminate 10 is formed in much the same manner as conventional decorative laminates. The layers are first stacked as a laminate lay-up and placed between steel plates. The laminate lay-up is then subjected to temperatures in the range of 110° C. to 155° C. and pressure of about 5.52 MPa to 11.03 MPa for a time sufficient to consolidate the laminate and cure the resins (generally about 25 minutes to an hour). The heat and pressure used generally correspond to a post-forming cycle or even a “greener” post-forming cycle.

The pressure and heat force the resin in the core layer to flow, cure and consolidate the sheets into a unitary laminated mass referred to in the art as a high pressure decorative laminate. Generally, more than one laminate is formed at one time. Multiple laminates are formed by inserting a plurality of assembled sheets in a stack Release sheets are positioned between the assembled sheets to separate the various laminates stacked together. After consolidation, the release sheets allow the individual laminates to be separated.

Once formed, the decorative laminate 10 may be used in the construction of a variety of structures through a compound forming process providing for compound forming in a three-dimensional space. The compound forming of the decorative laminate 10 is facilitated by the laminate's ability to both expand and contract without cracking or buckling during heating, forming and subsequent cooling.

For example, and as respectively shown in FIGS. 2 and 3, the decorative laminate 10 may be compound formed into the shape of a hemisphere (exhibiting expansion of the decorative laminate in accordance with the present invention) or “peanut” (exhibiting both expansion and contraction in accordance with the present invention).

With reference to FIG. 2, and in accordance with a preferred embodiment of the present invention, the process for compound forming the decorative laminate 10 into the shape of a hemisphere is accomplished through the use of a pneumatic pressure press 20. The formed laminate 10 is positioned over a hemisphere shaped molding surface 22 with the decorative surface 24 of the laminate 10 facing away from the hemisphere shaped molding surface 22. A silicone membrane 26 is positioned on the opposite side of the formed laminate 10 and a heat source 30 is positioned above the formed laminate 10 and the membrane 26.

Once the components are properly positioned, the laminate 10 is heated to a temperature of approximately 85° C. to 160% preferably approximately 115° C., and pressure is applied in the direction of the molding surface 22. It has been found that heating at higher temperatures may cause discoloration or blistering of the laminate. While a temperature of 115° C. is disclosed in accordance with a preferred embodiment of the present invention, compound forming in accordance with the present invention has been performed at surface temperatures as low as 85° C. or as high as 160% and those skilled in the art will appreciate that the surface temperatures utilized in the practice of the present invention may be varied to suit specific requirements.

As the formed laminate 10 is forced downwardly over the molding surface 22, the x-creped sheets of the formed laminate 10 stretch to conform to the surface of the molding surface 22. The decorative layer 12, an ECO-FILM sheet in accordance with a preferred embodiment of the present invention, stretches along with the x-creped kraft paper(s) 18 making up the core layer 14. The molded laminate is then permitted to cool, setting the resin in the shape of the molding surface, and the pressure is released.

In accordance with a preferred embodiment of the present invention, a molding assembly developed by ItalPresse USA, Inc. is used. The press generally operates at 0.4 to 0.5 MPa pressure with a silicone membrane that forces the laminate into the shape of the mold. However, those skilled in the art will appreciate the variety of molding techniques and apparatuses which may be used in accordance with the present invention without departing from the spirit thereof, for example, membrane thermoforming, vacuum thermoforming (including plug assisted forming), post-forming, hydroforming, insert injection molding, drape forming and compression molding (including matched mold forming).

The formed laminate may similarly be molded in a manner requiring contraction and expansion (or only contraction) of the laminate. For example, and with reference to FIG. 3, a “peanut” shaped molding surface 32 is disclosed. As with the molding processes discussed above, the laminate 10 to be formed is positioned over the “peanut” shaped molding surface 32 with the decorative surface 24 of the laminate 10 facing away from the molding surface 32, the silicone membrane 34 positioned on the opposite side of the formed laminate 10 and a heat source 36 positioned above the formed laminate 10 and the membrane 34. The laminate 10 is then heated to a temperature of approximately 115° C. and pressure is applied in the direction of the molding surface 32. As the sheets of the laminate 10 to be formed are forced downwardly over the molding surface 32, the sheets of the laminate 10 to be formed are stretched over the convex portions 38 of the molding surface 32 and contracted over the concave portions 40 of the molding surface 32. The molded laminate 10 is then permitted to cool, setting in the shape of the molding surface, and the pressure is released. The embodiments disclosed above present simple compound forming in the shape of a hemisphere or “peanut”, however, those skilled in the art will appreciate the virtually limitless shapes into which decorative laminates may be compound formed in accordance with the present invention. For example, it is contemplated that compound formed laminates in accordance with the present invention may be used as office furniture, including recent ergonomic designs incorporating compound radii; furniture with simple or compound radii; formed door fronts, drawer fronts, moldings, and panels for kitchen applications; architectural doors and formed facings; worktops with continuously formed edges, including, kitchen counters, commercial work surfaces, tables, etc.; wrap moldings; partitions with continuously formed edges; formed shower and catch basins; formed wall panels; ceiling panels; formed automotive composites consisting of a compound formable laminate decorative surface and a plastic substrate; formed institutional furniture components, including, desk seats, arm rests, etc.; formed case goods; formed store, and other institutional, fixtures; cafeteria food trays; dinnerware; decorative appliques and/or objects of art.

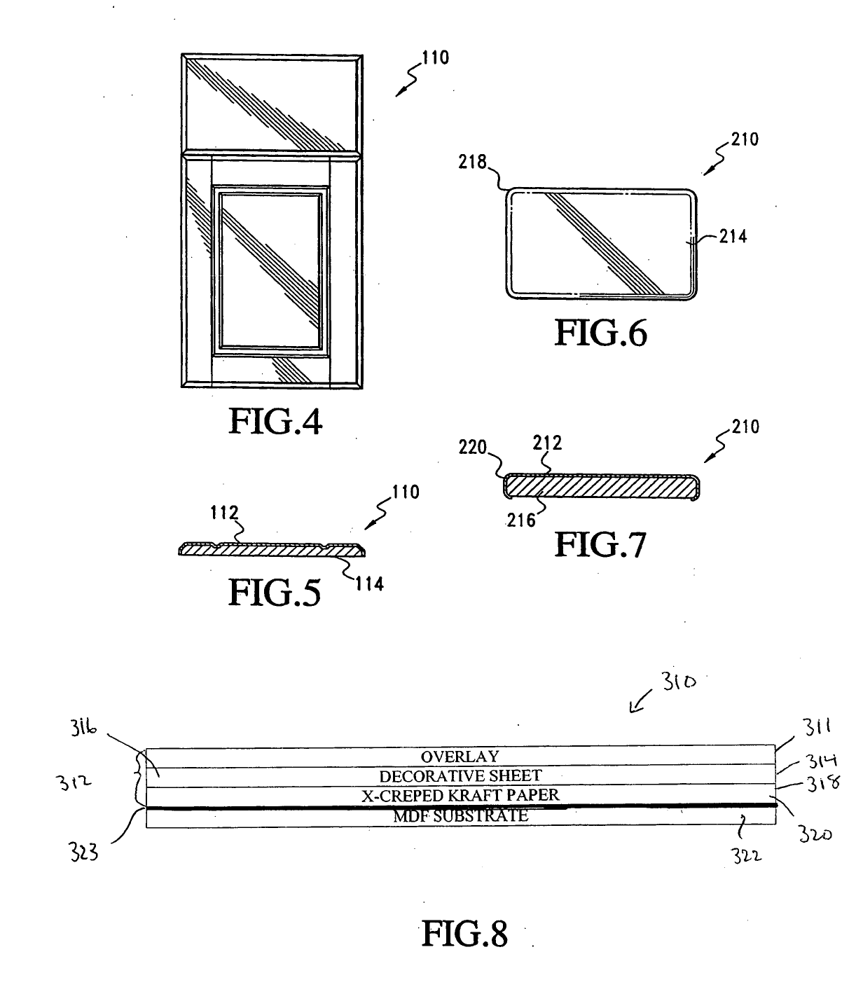

For example, and with reference to FIGS. 4 and 5, a cabinet door 110 is disclosed in accordance with the present invention. The cabinet door 110 includes a compound formed decorative laminate 112 secured to a medium density fiberboard (MDF) substrate 114. The surface of the cabinet door 110 includes a plurality of distinct concave and convex surfaces extending in various directions and formed within a three-dimensional space.

The cabinet door 110 is fabricated in much the same manner as described above with reference to FIGS. 2 and 3. Specifically, the compound formable decorative laminate 112 is first fabricated through the application of heat and pressure intended to cure and consolidate the layers making up the decorative laminate 112. Once the compound formable decorative laminate 112 is fabricated, it undergoes a compound forming process in which the decorative laminate 112 is molded to conform with the shape of the substrate 114 to which it is to be bound. Prior to molding, an adhesive is applied to the substrate 114 such that the laminate 112 will be adhesively bound to the substrate 114 upon the completion of the compound forming molding process. It is, however, contemplated that adhesive may be applied to the laminate backside surface rather than, or in addition to, the substrate.

In order to ensure that the exposed surface of the cabinet door 110 is completely covered with decorative laminate 112, the decorative laminate 112 is sized to be slightly larger than the substrate 114 to which it is molded and bound. As such, any edges of the decorative laminate 112 extending beyond the substrate 114 are trimmed off prior to considering the cabinet door a final product.

When used as a surfacing for kitchen cabinets, it is contemplated that compound formed laminates in accordance with the present invention will replace vinyl clad cabinet doors with a substantially more durable surface. Similarly, wood doors may also be replaced with compound molded laminates.

A further exemplary use of the present technology is disclosed in FIGS. 6 and 7 where a tabletop 210 having a compound formed decorative laminate surface 214 is disclosed. The tabletop 210 includes a compound formed decorative laminate 212 secured to a medium density fiberboard (MDF) substrate 216. The use of the present technology permits one to fully cover the tabletop 210 with a single sheet of compound formable decorative laminate 212. The substrate 216 of the tabletop 210 is prepared with rounded corners 218 and curved, or beveled, edges 220. The corners 218 and edges 220 provide a surface about which the compound formable decorative laminate 212 may be stretched and compressed, and those skilled in the art will appreciate different tabletop surface shapes which would be appropriate for application of the present technology.

The tabletop 210 is fabricated in much the same manner as described above with reference to FIGS. 2, 3, 4 and 5. Specifically, the compound formable decorative laminate 212 is first fabricated through the application of heat and pressure intended to partially cure and consolidate the layers making up the decorative laminate 212. Once the compound formable decorative laminate 212 is fabricated, it undergoes a compound forming process in which the decorative laminate 212 is molded to conform to the shape of the substrate 216 to which it is to be bound. The molding process causes the laminate 212 to bend, stretch and compress about the corners 218 and edges 220 of the substrate 216. Prior to molding, an adhesive is applied to the substrate 216 or laminate 212 such that the laminate 212 is adhesively bound to the substrate 216 upon the completion of the compound forming molding process.

In order to ensure that the exposed surface of the tabletop 210 is completely covered with decorative laminate 212, the decorative laminate 212 is sized to be slightly larger than the substrate 216 to which it is formed and bound. With this in mind, the edges of the decorative laminate 212 may either be trimmed away after molding or wrapped around and under the substrate 216 during the molding process (see FIGS. 6 and 7). Where the edges of the decorative laminate 212 are permitted to extend beyond the substrate 216, they are trimmed off prior final packaging of the tabletop 210.

In those instances where it is determined that either an overlay sheet or additional core layer sheets should be incorporated into the laminate, it has been found that the formed laminate is still highly suited for compound forming as discussed above. However, it has also been found that such laminates are not quite capable of bending in radii as tight as with the two sheet laminate discussed above.

While specific sheet materials, for example, kraft paper for the core layer and ECO-FILM for the decorative layer, are disclosed in accordance with preferred embodiments of the present invention, other paper or film types may be used without departing from the spirit of the present invention. Similarly, specific operating parameters and manufacturing techniques are described above, and those skilled in the art will appreciate the variations possible within the spirit of the present invention.

With reference to FIG. 8, an alternate embodiment of the present invention is disclosed. This embodiment includes a compound formable laminate panel 310 composed of a compound formable decorative laminate 312 in accordance with the present invention and a MDF substrate 322. More specifically, and in accordance with a preferred embodiment of the present invention, the compound formable decorative laminate 312 includes an overlay 311, a decorative layer 314 composed of a bilaterally stretchable decorative sheet 316 and a resin impregnated core layer 318 composed of a bilaterally stretchable kraft paper 320. The substrate 322 is a highly flexible medium density fiberboard.

The overlay 311 is a nonwoven material adapted for bilateral stretching similar to that provided by the decorative layer 314 and the core layer 318. Regardless of the material employed in practicing the present invention, the overlay 311 must exhibit high transparency and stretch characteristic allowing it to form with the underlying layers.

With reference to the decorative sheet 316 of the decorative layer 314, the decorative sheet 316 is commonly manufactured from a polyolefin sheet. In accordance with a preferred embodiment the polyolefin sheet is ECO-FILM, manufactured by Toppan, which is described as a polyolefin sheet material by Toppan. The decorative sheet 316 may include a solid color, a decorative design, or a rotogravure reproduction of natural materials, such as, wood, marble, leather, etc. The aesthetic characteristics of the decorative sheet are revealed as the laminate's decorative design upon completion of the decorative laminate 312.

The core layer 318 is preferably formed from a single sheet of phenolic resin impregnated kraft paper 320. The core layer 318 is constructed to be very thin so as to minimize the thickness of the resulting laminate 312, while similarly providing a stable structural member and improving the compound formability of the resulting decorative laminate 312. In accordance with a preferred embodiment of the present invention, before x-creping the kraft paper 320 had a basis weight of 123.7 g/m², however, those skilled in the art will appreciate that the weight may be varied without departing from the spirit of the present invention.

As discussed above with the prior embodiments, the kraft paper 320 of the core layer 318 is treated to impart desired softness and stretchability in both the x and y directions. The stretchable kraft paper 320 is then impregnated throughout and dried to remove solvent. The phenolic resin is then converted into a thermoset state during the pressing or compression molding step.

The fiberboard substrate 322 used in accordance with this embodiment is approximately 0.3175 cm thick In accordance with a preferred embodiment of the present invention, the fiberboard substrate 322 is medium density fiberboard (MDF). The MDF is specially manufactured to permit forming thereof through the use of a match mold press. While the MDF is used in accordance with a preferred embodiment of the present invention, other similar formable MDFs may be used without departing from the spirit of the present invention.

The low pressure decorative laminate panel 310 of the present embodiment is formed by stacking the overlay 311, decorative sheet 316, kraft paper 320 and fiberboard substrate 322, and placing the same between steel plates. It is further contemplated that it may be desirable to place adhesive or an adhesive film 323 between the kraft paper 320 and the substrate 322 to function as a tie layer therebetween. The laminate stack is then subjected to temperatures in the range of 115° C. to 160° C. and pressure between about 1.03 MPa to 2.93 MPa for a time sufficient to consolidate the laminate panel and cure the resins.

The pressure and heat force the resin in the core layer to flow, cure and consolidate the sheets into a unitary laminated mass referred to in the art as a decorative low pressure laminate. In addition, resin also flows into the substrate to establish the bond line. Low pressure decorative laminates in accordance with the present invention may be formed in a continuous manner through the use of a conveyor type processing assembly or a stepwise process using conventional pressing assemblies.

Once formed, and as discussed above with reference to the first disclosed embodiment, the decorative laminate panel 310 may be used in the construction of a variety of structures through a forming process providing for compound forming in three dimensions. The compound forming process also permits formation of a decorative laminate panel that requires both the expansion and contraction of the previously formed laminate. The forming process may be the same as previously discussed above, or it may include the use of a high-pressure matched mold press.

While a preferred embodiment of the present invention combines the MDF with the kraft paper and decorative sheet prior to the application of heat and pressure, it is contemplated that the MDF may be utilized as a conventional substrate which is adhesively bound to a decorative laminate which has previously been consolidated through the application of heat and pressure. When employed in this manner, the MDF is adhesively bound to either high pressure decorative laminate or low pressure decorative laminate, and the entire assembly is then subjected to a match mold press for compound molding in accordance with the present invention.

While the preferred embodiments have been shown and described, it will be understood that there is no intent to limit the invention by such disclosure, but rather, is intended to cover all modifications and alternate constructions falling within the spirit and scope of the invention.

1. A compound formable decorative laminate, comprising:
a decorative layer composed of a bilaterally stretchable polyolefin decorative sheet; and
a resin impregnated core layer composed of a bilaterally stretchable paper.

2. The decorative laminate according to claim 1, wherein the core layer is impregnated with a phenolic resin.

3. The decorative laminate according to claim 1, wherein the paper of the core layer is x-creped so as to impart stretchability thereto.

4. The decorative laminate according to claim 1, wherein the decorative sheet is capable of being stretched at least approximately 20%.

5. The decorative laminate according to claim 1, wherein the paper of the core layer is capable of being stretched at least approximately 20%.

6. The decorative laminate according to claim 1, further including an overlay positioned upon the decorative layer such that the decorative layer is positioned between the core layer and the overlay.

7. The decorative laminate according to claim 6, wherein the overlay is a nonwoven material.

8. The decorative laminate according to claim 7, wherein the overlay is composed of polyester fibers.

9. The decorative laminate according to claim 7, wherein the overlay is composed of a blend of polyester and rayon fibers.

10. A laminate lay-up, comprising:
a resin impregnated decorative layer composed of a bilaterally stretchable polyolefin decorative sheet; and
a resin impregnated core layer composed of a bilaterally stretchable paper.

11. The laminate lay-up according to claim 10, wherein the core layer is impregnated with a phenolic resin.

12. The laminate lay-up according to claim 10, wherein the paper of the core layer is x-creped so as to impart stretchability thereto.

13. The laminate lay-up according to claim 10, wherein the decorative sheet is capable of being stretched at least approximately 20%.

14. The laminate lay-up according to claim 10, wherein the paper of the core layer is capable of being stretched at least approximately 20%.

15. The laminate lay-up according to claim 10, wherein the core layer includes multiple sheets of bilaterally stretchable kraft paper.

16. The decorative laminate according to claim 10, further including an overlay positioned upon the decorative layer such that the decorative layer is positioned between the core layer and the overlay.

17. The decorative laminate according to claim 16, wherein the overlay is a nonwoven material.

18. A method of fabricating a compound formable decorative laminate, comprising:
providing a decorative sheet that is bilaterally stretchable, the decorative sheet being composed of a polyolefin;
providing a paper that is bilaterally stretchable;
impregnating the paper with a resin;
layering the decorative sheet and the paper, and
consolidating the layered decorative sheet and paper under heat and pressure to form a sheet of decorative laminate.

19. The method according to claim 18, wherein the step of impregnating the paper includes impregnating the paper with a phenolic resin.

20. The method according to claim 18, wherein the step of providing the paper includes x-creping so as to impart stretchability thereto.

21. The method according to claim 18, wherein the decorative sheet is capable of being stretched at least approximately 20%.

22. The method according to claim 18, wherein the paper is capable of being stretched at least approximately 20%.

23. The method according to claim 18, further including the step and positioning an overlay upon the decorative layer such that the decorative layer is positioned between the core layer and the overlay.

24. The method according to claim 23, wherein the overlay is nonwoven material.

25. A compound formable decorative laminate panel, comprising:
a decorative layer composed of a bilaterally stretchable polyolefin decorative sheet;
a compound formable substrate; and
a resin impregnated core layer positioned between the decorative layer and the substrate.

26. The decorative laminate panel according to claim 25, wherein the compound formable substrate is medium density fiberboard.

27. The decorative laminate panel according to claim 26, wherein the medium density fiber board is approximately 0.3175 cm thick.

28. The decorative laminate panel according to claim 26, wherein the core layer is composed of a bilaterally stretchable kraft paper.

29. The decorative laminate panel according to claim 28, wherein the kraft paper is x-creped so as to impart stretchability thereto.

30. The decorative laminate panel according to claim 25, further including an overlay positioned upon the decorative layer such that the decorative layer is positioned between the core layer and the overlay.

31. The decorative laminate panel according to claim 30, wherein the overlay is a nonwoven material.

32. A decorative laminate panel, comprising:
a compound formable decorative laminate including a bilaterally stretchable polyolefin decorative sheet and a resin impregnated core layer composed of a bilaterally stretchable kraft paper, and
a substrate to which the decorative laminate is bound.

33. The decorative laminate panel according to claim 32, wherein the core layer is impregnated with a phenolic resin.

34. The decorative laminate panel according to claim 32, wherein the kraft paper is x-creped so as to impart stretchability thereto.

35. The decorative laminate panel according to claim 32, wherein the decorative sheet is capable of being stretched at least approximately 20%.

36. The decorative laminate panel according to claim 32, wherein the kraft paper is capable of being stretched at least approximately 20%.

37. The decorative laminate panel according to claim 32, further including an overlay positioned upon the decorative layer such that the decorative layer is positioned between the core layer and the overlay.

38. The decorative laminate panel according to claim 37, wherein the overlay is a nonwoven material.

39. A compound formable decorative laminate, comprising:
a polyolefin decorative layer; and
a resin impregnated core layer.

40. The decorative laminate according to claim 39, wherein the core layer is composed of resin impregnated kraft paper.

41. The decorative laminate according to claim 40, wherein the core layer is impregnated with a phenolic resin.
